(19) United States
(12) Patent Application Publication
(10) Pub. No.: US 2012/0208380 A1
(43) Pub. Date: Aug. 16, 2012

(54) CONTACT RELIABILITY IN SEPARABLE ELECTRICAL INTERFACES

(75) Inventors: Joseph Kuczynski, Rochester, MN (US); Amanda E. Mikhail, Rochester, MN (US); Mark D. Plucinski, Rochester, MN (US)

(73) Assignee: INTERNATIONAL BUSINESS MACHINES CORPORATION, Armonk, NY (US)

(21) Appl. No.: 13/028,504

(22) Filed: Feb. 16, 2011

(51) Int. Cl. H01R 12/00

(52) U.S. Cl. 439/59

(57) ABSTRACT

A separable electrical interface is provided, the interface having a circuit card having one or more electrically conductive card edge tabs. Each of the card edge tabs has a raised, curved top surface profile. The separable electrical interface also includes one or more connector contacts. Each of the one or more connector contacts has a curved surface profile. The curved surface of each of the one or more connector contacts is positioned relative to a corresponding card edge tab to selectively engage the raised curved surface of the corresponding card edge tab at the point of final contact.

### BACKGROUND

1. Technical Field

The field of invention relates to electrical connectors. In particular, the field of invention relates to card edge connector interfaces.

2. Description of the Related Art

Electrical connectors join two mating electrical components through a separable electrical interface. This interface requires a robust mechanical design to ensure that the electrical interface stays intact, and allows for minimal degradation of the electrical path/signal across the separable interface. The contact mating area needs to be controlled mechanically, to ensure minimal degradation of the electrical path. The resulting contact area is a function of the geometry of the mating parts of the interface, the metallurgy involved, and the overall applied load to the mating halves of the interface.

In a typical card edge connector system, the mating interface is comprised of plated, conductive edge tabs of the circuit card, and conductive contacts of the card-edge connector. The edge tab connector design is desirable in many conventional electronics applications due to its relatively low complexity and low cost in comparison to other alternative designs. However, from a contact robustness and reliability perspective, the card-edge connector has geometric drawbacks that increase its risk to degradation of the electrical path across the separable interface. The foremost of these drawbacks is the fact that the card tabs are flat. In some conventional designs, designers have placed hertzian bumps on the connector side of the interface, but these bumps drastically impact the wear properties at the point of contact, and the gold plating is quickly gone after as few as one mating cycle.

Since the card edge connector interface is comprised of a connector contact sliding along and resting against a flat card edge tab, the risk of contamination entrapment and loss of contact normal force due to stress relaxation is significant.

### SUMMARY OF THE DISCLOSURE

The disclosure and claims herein are directed to an enhancement to the edge tab geometry of a card edge connector system to improve contact normal force and thus improve contact integrity. The invention provides an edge tab geometry such that it is not a conventionally flat surface, but instead is a curved raised surface profile which allows for a better point contact and stress concentration at the apparent contact surface.

In one embodiment, a separable electrical interface is provided, the interface having a circuit card having one or more electrically conductive card edge tabs. Each of the card edge tabs has a raised, curved top surface profile. The separable electrical interface also includes one or more connector contacts. Each of the one or more connector contacts has a curved surface profile. The curved surface of each of the one or more connector contacts is positioned relative to a corresponding card edge tab to selectively engage the raised curved surface of the corresponding card edge tab at the point of final contact. In one embodiment, the one or more connector contacts are oriented perpendicular to a major surface of the one or more card edge tabs, forming a cross-rods geometry at the final point of contact. In one embodiment, the curved surface of the card edge tabs is cylindrical in shape. In yet another embodiment, the raised, curved surface of the one or more card edge tabs has a convex profile relative to the major surface of the circuit card.

The foregoing and other features and advantages will be apparent from the following more particular description, as illustrated in the accompanying drawings.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1A (Prior Art) illustrates a conventional mating interface between plated, electrically conductive edge tabs of a circuit card and conductive contacts in the card edge connector.

FIG. 1B illustrates an embodiment of a mating interface between plated, electrically conductive edge tabs of a circuit card and conductive contacts in the card edge connector, wherein the edge tabs incorporate a curved raised top surface which allows for a better point contact and stress concentration at the apparent contact surface.

FIG. 2 illustrates the stress distribution between two spherical mating surfaces.

FIG. 3A illustrates a front-on view of the circuit card and the curved, raised electrically conductive edge tabs.

FIG. 3B illustrates a top-down view of the circuit card and the curved, raised electrically conductive edge tabs.

FIG. 3C illustrates a side view of the circuit card and the curved, raised electrically conductive edge tabs.

FIGS. 4A-4F (Prior Art) collectively illustrate a method for manufacturing curved, raised electrically conductive edge tab, in accordance with the present invention.

### DETAILED DESCRIPTION OF THE PREFERRED EMBODIMENTS

An enhancement to the edge tab geometry of a card edge connector system to improve contact normal force, and thus improve contact integrity, is provided. An edge tab geometry (and method of manufacture thereof) is provided such that it is not a conventionally flat surface, but instead is a curved raised surface which allows for a better point contact and stress concentration at the apparent contact surface.

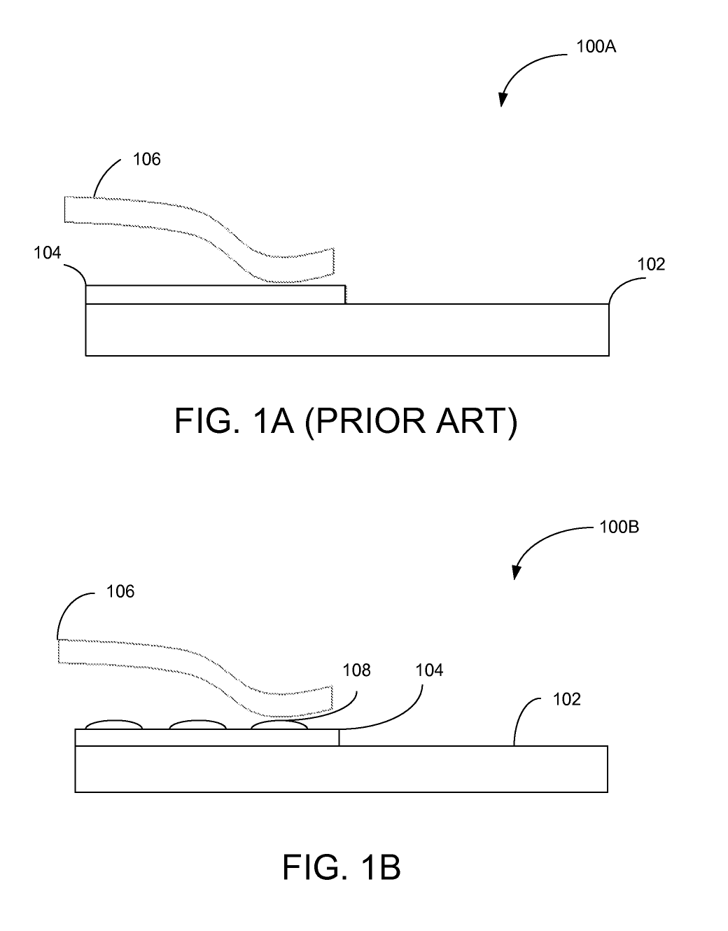

FIG. 1A (Prior Art) illustrates a conventional mating interface between plated, electrically conductive edge tabs of a circuit card and conductive contacts in the card edge connector, shown generally at 100A. In the illustrated embodiment, a circuit card 102 includes a plated, conductive edge tab 104 having a top flat surface which is raised from the major surface of the circuit card 102. A conductive connector contact 106 is positioned above the conductive edge tab 104, such that when the separable electrical interface is engaged, the conductive connector contact 106 slides along and rests against the top flat surface of the conductive edge tab 104. A typical conventional mating interface will contain a plurality of such conductive edge tabs 104 and conductive connector contacts 106. The conductive connector contact 106 may have either a flat surface (not illustrated) or a generally curved surface, as shown in FIG. 1A.

FIG. 1B illustrates an improved embodiment of a mating interface between plated, electrically conductive edge tabs of a circuit card and conductive contacts in the card edge connector, wherein each of the conductive edge tabs 104 incorporates a curved raised top surface 108 which allows for a better point contact and stress concentration at the apparent contact surface, shown generally at 1008. In the illustrative embodiment, the curved, raised top surface 108 is integrated into the top surface of each conductive edge tab 104 such that the curved surface of the conductive connector contact 106 is positioned 90 degrees relative to a corresponding card edge tab 104. When the electrical interface is engaged, the cylindrical shape of the conductive edge tabs rests on top and is in electrical contact with the cylindrical shape (i.e., the curved raised top surface 108) of the conductive edge tab 104. This stacked cylindrical arrangement is commonly referred to in the art as a “crossed rods” configuration.

The ideal contact geometry of an electrical interface is that of “crossed rods”. In a “crossed rods” type of contact geometry, there is a single point of contact between two cylinders, wherein the tangent point of the first cylinder's cross-section interfaces with the tangent point of the other cylinder's cross section. This ideal geometry occurs as a result of the high amount of stress generated at the interface. In such a configuration, the actual area of contact is not uniform, but is clumped into small regions called “a-spots”. The “crossed rod” geometry groups the a-spots close to each other, thus minimizing the vulnerability of the center a-spots to air and corroding gasses. Such a configuration improves contact integrity, robustness and reliability.

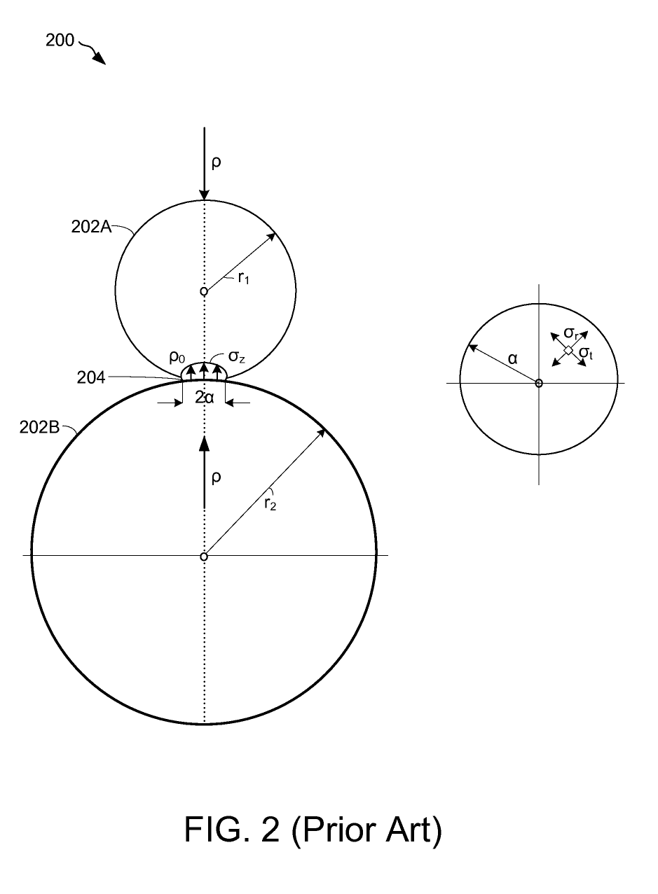

FIG. 2 illustrates the stress distribution between two mating spheres (202A and 202B) (“Contact Spots”, P. van Dijk, Expert in Contact Physics, www.pvdijk.com), shown generally at 200. In this illustration, the “a-spots” are shown generally at 204. The stress distribution between two mating spheres (202A and 202B) is similar to the crossed rods geometry described above. By incorporating a raised curved surface into both of the mating surfaces of the electrical interface, a superior contact is achieved.

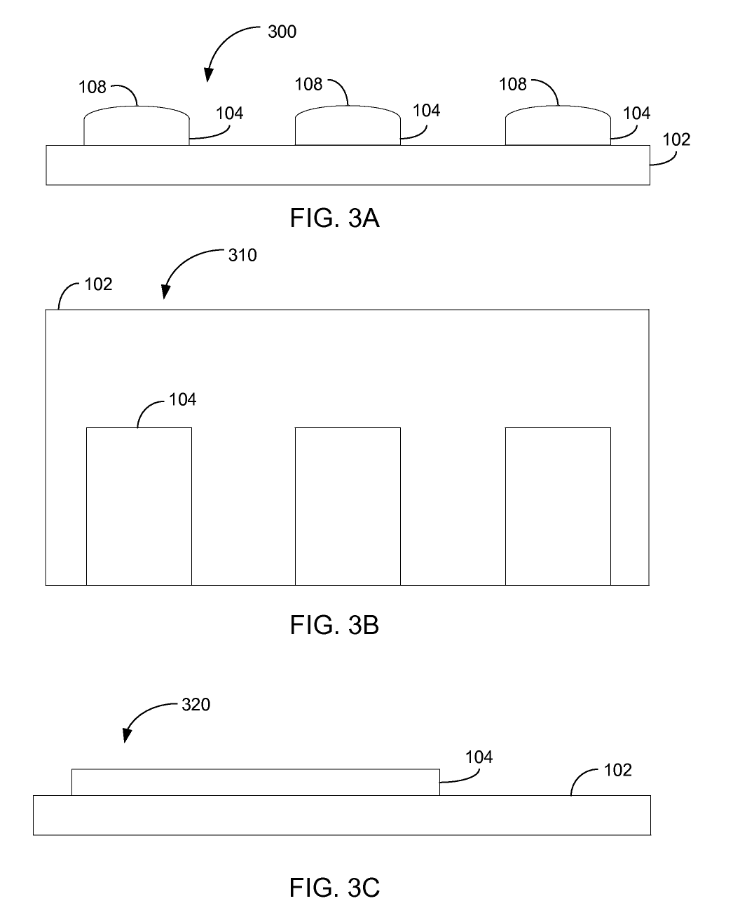

FIG. 3A illustrates a front-on view of the circuit card 102 and the curved, raised electrically conductive edge tabs 104, shown generally at 300. FIG. 3B illustrates a top-down view of the circuit card 102 and the curved, raised electrically conductive edge tabs 104, shown generally at 310. FIG. 3C illustrates a side view of the circuit card 102 and the curved, raised electrically conductive edge tabs 104, shown generally at 320.

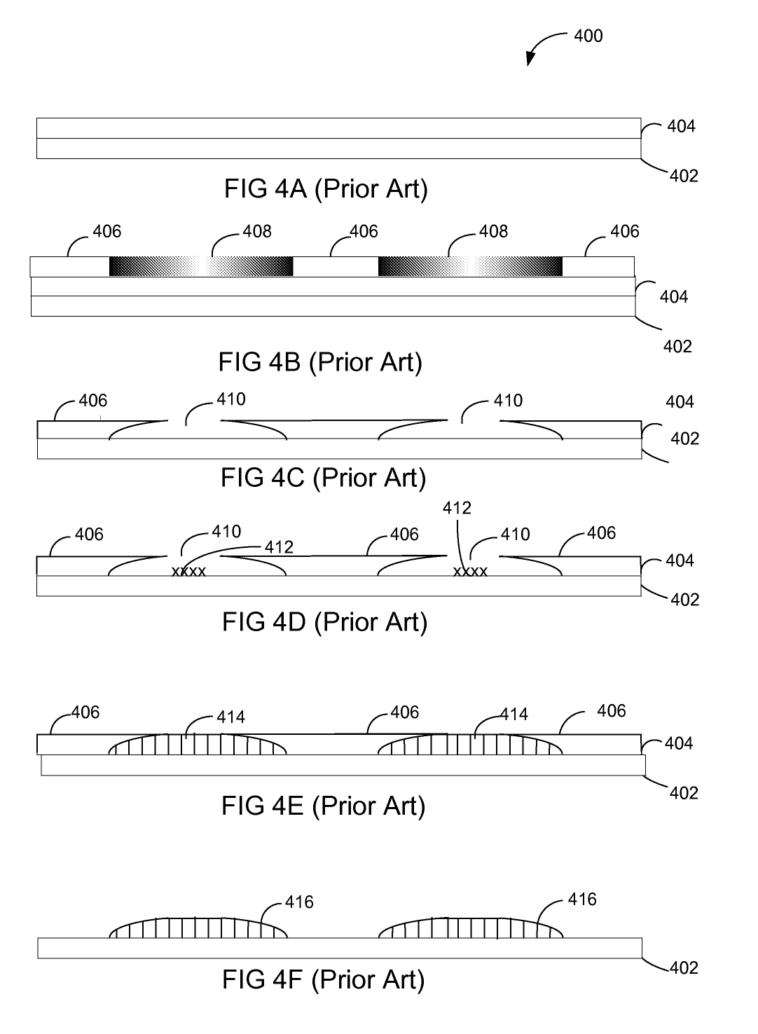

FIGS. 4A-4F (Prior Art) illustrates a cross-section of an electrically conductive card edge tab during various stages of photoresist application manufacturing, in order to produce a curved, raised edge tab, such as that used in the present invention. Commonly owned, co-pending application Ser. No. 12/870,041 entitled, “CIRCUIT APPARATUS HAVING A ROUNDED TRACE”, filed Aug. 27, 2010, describes a method which may be employed to manufacture a rounded trace. These same techniques may be employed to produce a curved, raised electrically conductive edge tab 104, in accordance with the present invention.

FIG. 4A (Prior Art) illustrates a positive tone photoresist layer 404 applied upon, laminated, or otherwise joined to a substrate 402. In certain embodiments, photoresist layer 404 may be a temporary layer and may be temporarily joined to substrate 402 using various adhesives, epoxies, or the like (e.g., the photoresist may be applied as a dry film or liquid, etc.). Substrate 402 may be a flexible laminate or rigid laminate depending on the application of the desired circuit and may be made from various dielectric material(s), such as, polytetrafluoroethylene, FR-4, FR-1, CEM-1, CEM-3, polyimide, or the equivalent.

Photoresist layer 404 is sensitive to light, and in certain embodiments, may be sensitive to ultraviolet light, deep ultra violet light, the H and I lines of a mercury-vapor lamp, etc. When exposed to light, the positive tone photoresist layer 404 becomes soluble. The height of the photoresist layer 404 is related to the desired height of the curved raised surface of the curved, raised edge tab.

A positive tone photoresist is a type of photoresist in which the portion of the photoresist that is exposed to light becomes soluble to a photoresist developer. The portion of the positive tone photoresist that is unexposed remains insoluble to the photoresist developer that may be later used to dissolve the exposed portion of the positive tone photoresist.

FIG. 4B (Prior Art) illustrates the cross section of the card edge tab during an artwork registration manufacturing stage according to embodiments of the present invention. Artwork is applied upon, registered or otherwise joined to the photoresist layer 404. Artwork has one or more adaptable-mask sections 408 and one or more continuous-mask sections 406. Adaptable mask sections 408 allows a graded, attenuated, decreasing, increasing, or otherwise user defined amount of light to pass through the adaptable-mask section 408 across the length of section 408. Continuous-mask section 406 allows a similar or otherwise constant amount of light to pass through the continuous-mask section 406 across the length of section 406. Typically, continuous-mask section 406 allows either all light or no light to pass through the section 406.

The density of the adaptable mask section 408 is graded, attenuated, less or more dense, or is otherwise user defined across the length of section 408 to allow for a predetermined varying amount of light to pass through adaptable-mask section 408. Therefore when exposed to light, a predetermined varying amount of light may penetrate photoresist layer 404 creating a soluble section and an insoluble section in the photoresist layer beneath the adaptable-mask section 408.

FIG. 4C (Prior Art) illustrates the removal of the artwork and soluble sections of the developed photoresist layer 404 results in one or more geometric voids 410 used later to develop the curved, raised portion of the edge tab.

FIG. 4D (Prior Art) depicts a cross-section of the card edge tab after a seed application stage. An electroplating seed layer 412 may comprise an adhesion layer and a plating-seed layer. The adhesion layer provides a more effective bonding surface for the plating-seed layer. The adhesion layer provides a more effective bonding surface for the plating-seed layer. The plating-seed layer may be a gold plating seed, hard gold plating seed, copper plating seed, palladium plating seed, etc. The plating-seed layer facilitates electroplating deposition of conductive traces on substrate 402.

During a plating stage, the substrate 402 and photoresist layer 404 are immersed in an electrolyte solution containing one or more dissolved metal salts as well as other ions that permit the flow of electricity. A rectifier supplies a direct current to the trace material, oxidizing the metal atoms that comprise it, allowing them to dissolve in the solution. The dissolved metal ions in the electrolyte solution are reduced at the interface between the solution and the seed layer 412, such that they plate onto the seed layer. A second plating stage may be used to create a gold-plated copper trace. Subsequent to plating, the trace material 414 fills the mold created by geometric voids 410. As a result a curved, rounded profile is created, as shown in FIG. 4E (Prior Art).

After the curved, raised portions have been formed in conformance with the mold or side walls of geometric voids 410, developed photoresist layer 402 is no longer required, and may be stripped off using acetone or other known photoresist stripping solvents (e.g., aqueous alkaline solution, etc.). A curved rounded edge tab 416 has now been constructed, as shown in FIG. 4F (Prior Art).

1. A separable electrical interface, comprising:
a circuit card having one or more electrically conductive card edge tabs, the card edge tabs having a raised, curved top surface profile;
one or more connector contacts, each having a curved surface profile, each of the one or more connector contacts' curved surface positioned relative to a corresponding card edge tab to selectively engage the raised curved surface of the corresponding card edge tab at a point of final contact.

2. The separable electrical interface of claim 1, wherein the curved surface of the card edge tabs is cylindrical in shape.

3. The separable electrical interface of claim 1, wherein the one or more connector contracts are oriented perpendicular to a major surface of the card edge tabs, forming a cross-rods geometry at the final point of contact.

4. The separable electrical interface of claim 1, wherein the raised, curved surface of the one or more card edge tabs has a convex profile relative to a major surface of the circuit card.

5. The separable electrical interface of claim 1, wherein at the point of final contact, a first tangent point of the card edge tab's curved raised surface cross-section interfaces with a second tangent point of the connector contact's curved surface cross section.
